(19) United States
(12) Patent Application Publication
(10) Pub. No.: US 2024/0380296 A1
(43) Pub. Date: Nov. 14, 2024

(54) ELECTRIC AXIAL FLUX MACHINE

(71) Applicant: Schaeffler Technologies AG & Co. KG, Herzogenaurach (DE)

(72) Inventors: Jörg Kegeler, Schleusingen (DE); Karsten Feindt, Amt Wachsenburg (DE)

(21) Appl. No.: 18/689,024

(22) PCT Filed: Aug. 10, 2022
(86) PCT No.: PCT/DE2022/100588

§ 371 Date: Mar. 4, 2024

(30) Foreign Application Priority Data
Sep. 9, 2021 (DE) 10 2021 123 387.9
Jul. 6, 2022 (DE) 10 2022 116 815.8

(51) Int. Cl. H02K 21/24; B25J 9/12; H02K 1/2798; H02K 3/26

(52) U.S. Cl. CPC H02K 21/24; B25J 9/126; H02K 1/2798; H02K 3/26; H02K 2203/03; H02K 2213/03

(57) ABSTRACT

The invention relates to an electric axial flux machine (1), comprising: a first stator (2) having a first multi-phase, more particularly three-phase, winding comprising N first stator poles (5), which are mutually spaced in a circumferential direction (10) of the axial flux machine (1); a second stator (3) having a second multi-phase, more particularly three-phase, winding comprising N second stator poles (6), which are mutually spaced in a circumferential direction (10) of the axial flux machine (1), a plurality of first stator poles (5) of the first winding and a plurality of second stator poles (6) of the second winding being interconnected to form a first phase (U) of the axial flux machine (1); a rotor (4), which is disposed between the first stator (2) and the second stator (3) and which can be rotated relative to the first and second stators (2, 3); a power source for energizing the first and second stators (2, 3); wherein: the first stator (2) and the second stator (3) are configured and disposed such that the second stator poles (6) of the first phase (U), which are provided as part of the second stator (3), are offset by an offset angle (14) in the circumferential direction (10) in relation to the first stator poles (5) of the first phase (U), which are provided as part of the first stator (2); the rotor (4) has a plurality of rotor poles (8); a rotor pole distance (7) is determined by the angular distance between two adjacent rotor poles (8), and the offset angle (14) is a single rotor pole distance (7) or a multiple of the single rotor pole distance (7); and the power source for energizing the first and second stators (2, 3) is designed such that the direction of the torque on the rotor (4) caused by the first and second stators (2, 3) is the same.

### CROSS-REFERENCE TO RELATED APPLICATIONS

The present application is the U.S. National Phase of PCT Patent Application Number PCT/DE2022/100588, filed on Aug. 10, 2022, which claims priority to German Patent Application Serial Number 10 2021 123 387.9, filed on Sep. 9, 2021, and German Patent Application Serial Number 10 2022 116 815.8, filed Jul. 6, 2022, the entire disclosures of which are incorporated by reference herein.

### TECHNICAL FIELD

The disclosure relates to an electric axial flux machine comprising a first stator having a first multi-phase, more particularly three-phase, winding comprising N first stator poles, which are mutually spaced in a circumferential direction of the axial flux machine, a second stator having a second multi-phase, more particularly three-phase, winding comprising N second stator poles, which are mutually spaced in a circumferential direction of the axial flux machine, a plurality of first stator poles of the first winding and a plurality of second stator poles of the second winding being interconnected to form a first phase of the axial flux machine, and a rotor, which is disposed between the first stator and the second stator and which can be rotated relative to the first and second stators.

### BACKGROUND

The structure of such axial flux machines is also known as a double stator arrangement. For example, axial flux motors from Schaeffler's UPRS series, which can be used as drives in industrial robots, are known in the prior art. In such axial flux machines with a double stator arrangement, the rotor is rotatably arranged between two external stators.

If such axial flux machines are to be used in industrial robots, it is desirable if the axial flux machine can provide the highest possible torque and be compact and as light as possible at the same time, such that the axial flux machine can be arranged as part of an articulated arm bearing of an industrial robot.

Against this background, the object is to increase the torque of an electric axial flux machine without increasing material usage.

### SUMMARY

This object is achieved by an electric axial flux machine having the features of claim 1. Said machine has: a first stator having a first multi-phase, more particularly three-phase, winding comprising N first stator poles, which are mutually spaced in a circumferential direction of the axial flux machine, a second stator having a second multi-phase, more particularly three-phase, winding comprising N second stator poles, which are mutually spaced in a circumferential direction of the axial flux machine, a plurality of first stator poles of the first winding and a plurality of second stator poles of the second winding being interconnected to form a first phase of the axial flux machine, a rotor which is disposed between the first stator and the second stator and which can be rotated relative to the first and second stators, and a power source for energizing the first and second stators, wherein the first stator and the second stator are configured and disposed such that the second stator poles of the first phase, which are provided as part of the second stator, are offset by an offset angle in the circumferential direction in relation to the first stator poles of the first phase, which are provided as part of the first stator, wherein the rotor has a plurality of rotor poles, wherein a rotor pole distance is determined by the angular distance between two adjacent rotor poles, and the offset angle is a single rotor pole distance or a multiple of the single rotor pole distance, and wherein the power source for energizing the first and second stators is designed such that the direction of the torque on the rotor caused by the first stator and second stator is the same.

In the axial flux machine according to the disclosure, the two stators are disposed and interconnected in such a way that two stator poles of the two stators, which belong to a common phase of the axial flux motor, are offset by the offset angle in the circumferential direction. In other words, the two stator poles of the two stators, which belong to a common phase of the axial flux motor, can be connected by a virtual connecting line which is not arranged perpendicular to the circumferential direction, more particularly not arranged parallel to an axial direction of the axial flux machine. Instead, the stator poles of the common phase are arranged offset on the two stators in such a way that the virtual connecting line between these stator poles forms an angle other than 90° with the circumferential direction of the axial flux machine.

The offset arrangement of the stator poles of the two stators results in advantages compared to a non-offset stator arrangement known from the prior art with regard to the excitation field of the rotor and the field of the stators, which are described below.

With a non-offset stator arrangement, the stator poles of the two stators are disposed in mirror image with respect to the rotor. The excitation field of the rotor therefore causes a symmetrical distribution of the magnetic flux density in both the rotor and the two stators. With the offset stator arrangement according to the disclosure, the mirror-image arrangement with respect to the rotor is omitted. This results in an asymmetrical distribution of the excitation field in the rotor and the stators. It has been found that this asymmetrical distribution of the excitation field in the rotor leads to a higher excitation flux in the two stators compared to the non-offset arrangement of the stators. Due to the higher excitation flux in the stators, the torque of the axial flux machine can be increased with an identical stator design.

With the non-offset arrangement of the stators, the magnetic flux caused by a stator only affects the side of the rotor facing the respective stator. The magnetic flux is distributed symmetrically with respect to the rotor. There is substantially no magnetic flux in an axial direction from one side of the symmetry to the other. In addition, the magnetic flux density in the rotor caused by the stator poles depends on the angular position in the circumferential direction of the rotor. In the offset arrangement of the stators according to the disclosure, a strongly energized stator pole is opposite a weakly energized stator pole when energized according to the current phase position and commutation. This causes the distribution of the magnetic flux caused by the stator to become asymmetrical in the rotor. It has been found that the magnetic flux density through the cross section of the rotor is, however, more balanced in the circumferential direction of the rotor. The ferromagnetic circuit of the axial flux machine is therefore used more evenly than is the case with the known arrangement without stator offset, thus reducing the magnetic resistance of the rotor and increasing overall magnetic flux. In this respect, the torque of the electric axial flux machine according to the disclosure can be increased without increasing material usage.

The first stator poles of the first winding or the second stator poles of the second winding may be at an identical angular distance from one another, which can also be referred to as the pole pitch of the stator or stator pole pitch.

Preferably, a plurality of first stator poles of the first winding and a plurality of second stator poles of the second winding are interconnected to form a second phase of the axial flux machine. Particularly preferably, a plurality of first stator poles of the first winding and a plurality of second stator poles of the second winding are interconnected to form a third phase of the axial flux machine. The first poles of the first winding are interconnected in such a way that a first pole of the first winding is assigned exclusively to one phase of the axial flux machine. The second poles of the second winding are interconnected in such a way that a second pole of the second winding is assigned exclusively to one phase of the axial flux machine.

According to one advantageous embodiment of the disclosure, it is provided that the rotor has a plurality of rotor poles, wherein a rotor pole distance is determined by the angular distance between two adjacent rotor poles, and the offset angle is a single rotor pole distance or a multiple of the single rotor pole distance. It has been found that, in such an embodiment, torque can be advantageously increased.

According to one advantageous embodiment of the disclosure, it is provided that the rotor has a plurality of rotor poles, wherein a rotor pole distance is determined by the angular distance between two adjacent rotor poles, and the offset angle is twice the rotor pole distance or a multiple of twice the rotor pole distance. It has been found that, in such an embodiment, torque can be advantageously increased.

According to one advantageous embodiment of the disclosure, it is provided that the rotor has a plurality of rotor poles, wherein a rotor pole distance is determined by the angular distance between two adjacent rotor poles, and the offset angle is three times the rotor pole distance or a multiple of three times the rotor pole distance. It has been found that, in such an embodiment, torque can be advantageously increased.

According to one advantageous embodiment of the disclosure, it is provided that the rotor has a plurality of rotor poles, wherein a rotor pole distance is determined by the angular distance between two adjacent rotor poles, and the offset angle is determined as an integer n times the rotor pole distance, with

$$n = kgV ( \frac{N}{Ph} ; M ) \cdot \frac{Ph}{2 N}$$

wherein
kgV least common multiple;
N number of stator poles;
Ph number of phases;
M number of rotor poles.

The basis of this relationship is the fact that for each topology of an axial flux machine, an initial motor can be specified, which forms a smallest part of the machine, which can be repeatedly joined together as a whole in order to obtain a complete axial flux machine. The length of the initial motor can be specified as n times the rotor pole distance. It has been found that torque can be advantageously increased if the offset angle corresponds to half the length of an initial motor, rounded to an integral rotor pole distance.

It may optionally be provided that the winding of the first stator and the winding of the second stator are energized with opposing current directions. In this way, it can be ensured that the direction of the torque on the rotor caused by the first stator and second stator is the same. Reversing the current direction is useful in the case where the offset angle corresponds to a single or odd multiple of the rotor pole distance. In this case, the current direction in one of the stators can be reversed compared to an axial flux machine with no offset. In this way, it can be ensured that the direction of the torque on the rotor caused by the first stator and second stator is the same. In other words, this ensures that the back EMF is maximized. Without reversing the current direction as described above compared to an axial flux machine with stators that are not mutually offset, there would otherwise be a drastic reduction in the back EMF and thus also in the torque provided.

The above-mentioned change in current direction compared to an identically designed axial flux machine without stator offset is to be deemed equivalent to any other measure that brings about a change in sign of the magnetic axial flux component generated by the coils of one of the stators compared to the non-offset arrangement. For example, the winding direction of the coils of one of the stators can be reversed compared to the non-offset arrangement, while the power source does not reverse the current direction compared to the non-offset arrangement.

If, on the other hand, the offset angle is selected such that n is an even number, the current direction of the two stators advantageously corresponds to that which would also be selected to maximize torque in a non-offset arrangement of the same design.

According to one advantageous embodiment of the disclosure, it is provided that the first winding is a toothed coil winding with first stator poles designed as coils and the second winding is a toothed coil winding with second stator poles designed as coils. The design as a toothed coil winding offers the advantage that the respective stator can be formed from a plurality of modules, for example individual toothed coils, which can make production of the axial flux machine easier. The first stator preferably comprises a plurality of first stator teeth, with a first stator tooth being assigned to each first stator pole, more particularly with the coil of the respective first stator pole being arranged around the corresponding first stator tooth. The second stator preferably comprises a plurality of second stator teeth, with a second stator tooth being assigned to each second stator pole, more particularly with the coil of the respective second stator pole being arranged around the corresponding second stator tooth.

According to one advantageous embodiment of the disclosure, it is provided that the first stator comprises a first circuit board and the first winding has first conductor tracks which are arranged in the first circuit board and that the second stator comprises a second circuit board and the second winding has second conductor tracks which are arranged in the second circuit board. Such printed circuit boards are also referred to as PCBs (printed circuit boards). Such a design makes it possible to dispense with conventional winding techniques for producing the winding and enables good dissipation of heat loss. The circuit board preferably comprises a plurality of passage openings for introducing coil cores, so enabling guidance of the magnetic field generated by the conductor tracks of the circuit board.

According to one advantageous embodiment of the disclosure, it is provided that the rotor has M rotor poles. The number M of rotor poles is preferably not equal to the number N of stator poles. The number M of rotor poles is particularly preferably greater than the number N of stator poles. For example, the axial flux machine may be designed with a configuration M=14 and N=12. Alternatively, the number M of rotor poles may be smaller than the number N of stator poles. For example, the axial flux machine may be designed with a configuration M=22 and N=24 or M=16 and N=18.

According to one advantageous embodiment of the disclosure, it is provided that the magnetic poles are formed by permanent magnets embedded in a main body of the rotor, the permanent magnets having magnetization in the circumferential direction of the axial flux machine. Such an embodiment enables a high degree of accuracy in the arrangement of the magnetic poles on the rotor. The permanent magnets can generate a magnetic flux in the circumferential direction of the axial flux machine, which emerges from one end face, more particularly two end faces, of the particularly disc-shaped rotor. In this respect, the respective rotor pole is defined by a position between two adjacent permanent magnets of the rotor. The pole width of such a rotor pole is defined by the distance between the centers of adjacent permanent magnets.

According to an alternative advantageous embodiment of the disclosure, it is provided that the rotor poles are formed by permanent magnets arranged on an end face of the rotor, in particular circular sector-shaped or circular ring sector-shaped permanent magnets. In such an embodiment, the rotor poles are each formed by a permanent magnet. The pole width thus corresponds to the distance between the centers of adjacent permanent magnets in the circumferential direction of the axial flux machine. The permanent magnets are preferably magnetized in an axial direction, i.e., parallel to an axis of rotation of the rotor.

A further object of the disclosure is a drive module for moving an articulated arm of an industrial robot having an electric axial flux machine as described above.

The same advantages can be achieved with the drive module as have already been described in connection with the electric axial flux machine.

### BRIEF DESCRIPTION OF THE DRAWINGS

Further details and advantages of the disclosure will be explained below with reference to the exemplary embodiment shown in the drawings. In the drawings:

FIG. 1 shows a schematic side view of an exemplary embodiment of an electric axial flux machine according to the disclosure;

FIG. 2 shows a schematic representation of a first exemplary embodiment of a rotor of an electric axial flux machine according to the disclosure;

FIG. 3 shows a schematic representation of a second exemplary embodiment of a rotor of an electric axial flux machine according to the disclosure;

FIG. 4 shows a schematic representation of an axial flux machine without stator offset;

FIG. 5 shows a schematic representation of a further exemplary embodiment of an electric axial flux machine with offset according to the disclosure;

FIG. 6 shows a representation of the magnetic flux density of the excitation field of the electric axial flux machine according to FIG. 4;

FIG. 7 shows a representation of the magnetic flux density of the excitation field of the electric axial flux machine of the disclosure according to FIG. 5;

FIG. 8 shows a diagram of the magnetic flux linkage; and

FIG. 9 shows an industrial robot having a drive module according to an exemplary embodiment of the disclosure.

### DETAILED DESCRIPTION

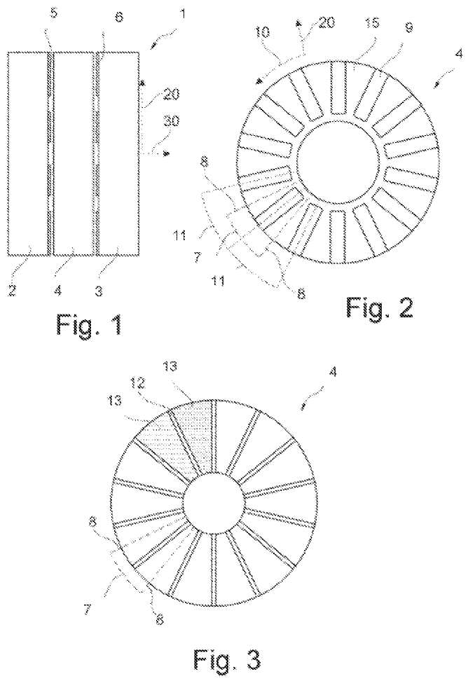

FIG. 1 shows a schematic side view of an exemplary embodiment of an electric axial flux machine 1 according to the disclosure. The electric axial flux machine 1 comprises a first stator 2, a second stator 3 and a rotor 4 which is disposed between the first stator 2 and the second stator 3 and which can be rotated relative to the two stators 2, 3. In this respect, the axial flux motor 1 has a double stator structure having a rotor 4 designed as an internal rotor. The first stator 2 and the second stator 3 each comprise a multi-phase, here three-phase, winding with N stator poles 5, 6. The stator poles 5,6 are mutually spaced in each case by an identical angular distance in a circumferential direction 10 of the axial flux machine. This angular distance corresponds to the stator pole pitch.

The first winding of the first stator 2 has a plurality of, here three, phases. The first stator poles 5 are thus subdivided into a plurality of, here three, phases. The second winding of the second stator 3 likewise has a plurality of, here three, phases. The second stator poles 6 of this second winding are thus also subdivided into a plurality of, here three, phases U, V, W. The first stator poles 5 of the first winding and the second stator poles 6 of the second winding are interconnected to form a first phase U of the axial flux machine. Furthermore, a plurality of first stator poles 5 of the first winding and a plurality of second stator poles 6 of the second winding are interconnected to form a second phase V of the axial flux machine. In addition, a plurality of first stator poles 5 of the first winding and a plurality of second stator poles 6 of the second winding are interconnected to form a third phase W of the axial flux machine.

The first and second windings of the electrical axial flux machine 1 can be designed, for example, as toothed coil windings with stator poles 5, 6 designed as coils. The first stator 3 may comprise a plurality of first stator teeth, with a first stator tooth being assigned to each first stator pole 5, more particularly with the coil of the respective first stator pole 5 being arranged around the corresponding first stator tooth. The second stator 4 may comprise a plurality of second stator teeth, with a second stator tooth being assigned to each second stator pole 6, more particularly with the coil of the respective second stator pole 6 being arranged around the corresponding second stator tooth. Particularly preferably, the stators 2, 3 each comprise a circuit board and the respective winding has conductor tracks which are arranged in the respective circuit board.

The representations in FIG. 2 and FIG. 3 show alternative embodiments of the rotor 4 of the axial flux machine according to the disclosure.

The rotor 4 according to FIG. 2 has rotor poles 8, which are formed by the interaction in each case of two adjacent permanent magnets 9 embedded in a main body 15 of the rotor 4. The permanent magnets 9 are magnetized in the circumferential direction 10 and generate a magnetic flux in the circumferential direction 10 of the axial flux machine 1 or of the rotor 4, which emerges from the disk-shaped rotor 4 at both end faces thereof. In this respect, the respective rotor pole 8 is defined by a position between two adjacent permanent magnets 9 of the rotor 4. The rotor pole pitch 7, also referred to as rotor pole distance 7, is defined by the distance 11 between adjacent permanent magnets 9.

The rotor according to FIG. 3 has rotor poles 8, which are formed by permanent magnets 13 shaped as sectors of a ring and arranged on one end face of the rotor 4. A gap 12 is provided in each case between adjacent permanent magnets 13, in which gap the main body of the rotor 4 is not occupied by a permanent magnet 13. The permanent magnets 13 are magnetized in the axial direction 30, i.e., parallel to the axis of rotation of the rotor 4. In this respect, the magnetic poles 8 of this rotor 4 are in each case formed by a permanent magnet 13. The rotor pole pitch 7, also referred to as rotor pole distance 7, is likewise shown in FIG. 3.

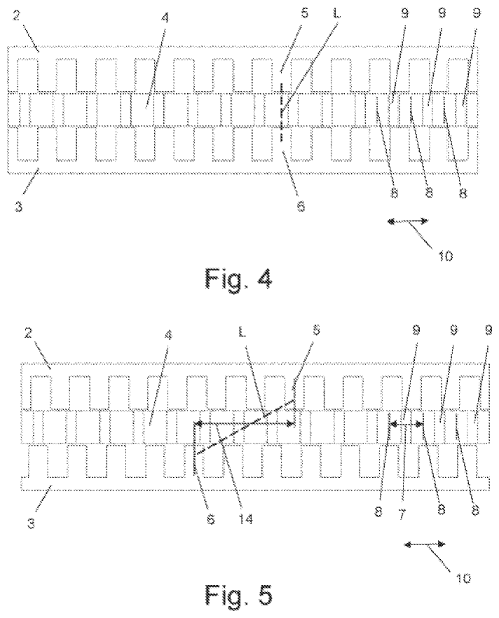

The representations in FIGS. 4 and 5 show a non-inventive (FIG. 4) and an inventive (FIG. 5) configuration of an axial flux machine in a schematic development along the circumferential direction 10. A stator 4 according to FIG. 2 is shown with embedded permanent magnets 9, which are magnetized in the circumferential direction 10. However, the inventive and non-inventive configurations may also be implemented with a stator according to 4.

FIG. 4 shows a non-inventive embodiment of an axial flux machine, in which the first stator 2 and the second stator 3 are configured and disposed such that the second stator poles 6 of the first phase U, which are provided as part of the second stator 3, are not offset in the circumferential direction 10 in relation to the first stator poles 5 of the first phase U, which are provided as part of the first stator 2. In this respect, two stator poles 5, 6 of the two stators 2, 3, which belong to a common phase of the axial flux motor 1, are connected by a virtual connecting line L, which is arranged perpendicular to the circumferential direction 10.

The representation in FIG. 5 shows an exemplary embodiment according to the disclosure of an axial flux machine 1, in which the first stator 2 and the second stator 3 are configured and disposed such that the second stator poles 6 of the first phase U, which are provided as part of the second stator 3, are offset by an offset angle 14 in the circumferential direction 10 in relation to the first stator poles 5 of the first phase U, which are provided as part of the first stator 2. In this respect, two stator poles 5, 6 of the two stators 2, 3, which belong to a common phase of the axial flux motor 1, are connected by a virtual connecting line L, which is arranged obliquely to the circumferential direction 10. The rotor pole distance 7 is determined by the angular distance between two adjacent rotor poles 8, which is identical to the angular distance between two adjacent permanent magnets 9. The offset angle 14 is selected as a multiple of the rotor pole distance 7, here as three times the rotor pole distance 7.

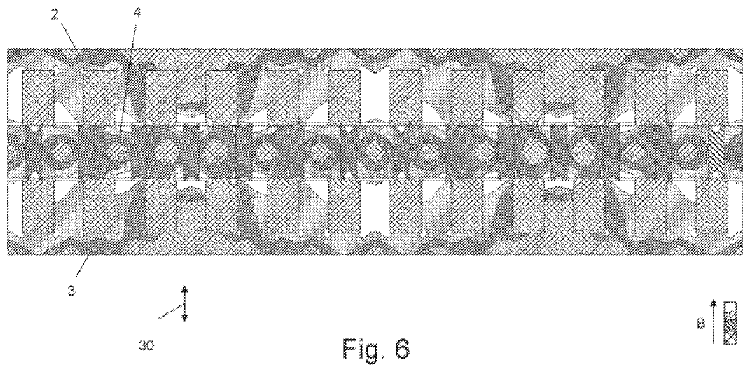

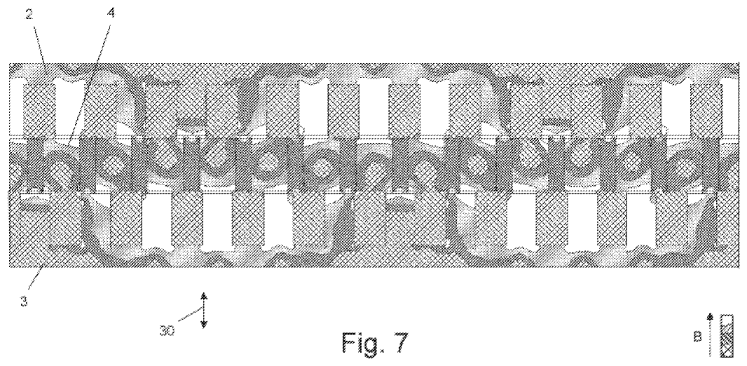

FIG. 6 shows the distribution of the magnetic flux density B in the axial flux machine according to FIG. 4, which is caused by the excitation field of the rotor 3. FIG. 7 shows the distribution of the magnetic flux density B in the axial flux machine according to FIG. 5, which is caused by the excitation field of the rotor 3. The areas with cross hatching designate areas of low magnetic flux density B and the white areas designate areas of high magnetic flux density B. The areas with simple hatching designate areas of medium magnetic flux density, see key in FIG. 6 and FIG. 7, respectively.

A comparison between FIGS. 6 and 7 shows that the field distribution becomes asymmetrical due to the offset of the stator teeth of the first stator 2 and second stator 3. For example, the areas of low flux density within the rotor 4 in the axial flux machine without offset (FIG. 6) lie in a plane perpendicular to the axis of rotation of the motor, which runs through the rotor 4. In the axial flux machine 1 with offset according to the disclosure (FIG. 7), these areas of low flux density are not arranged in one plane, but are shifted depending on position along the circumferential direction either in the direction of the first stator 2 or in the direction of the second stator 3. This asymmetrical distribution leads to an increased excitation flux in the two stators 2, 3. This is because a portion of the flux from unused field gaps can be used in the respectively opposing stator. Due to the higher excitation flux according to FIG. 7, the achievable torque of the axial flux machine 1 increases compared to the axial flux machine according to FIG. 6 with identical rotor design, more particularly with identical design of the permanent magnets of the rotor.

With a symmetrical arrangement of the stators 2, 3 without rotation according to FIG. 6, a completely symmetrical flux density distribution forms in both the energized and non-energized states, and the center line of the rotor 4 forms the line of symmetry. The magnetic flux of the first stator 2 only affects its side of the rotor 4. The flux is distributed symmetrically between both the rotor and stator sides. There is no magnetic flux in the axial direction 30 from one side of symmetry to the other. The magnetic flux density in the rotor 4 is strongly angle (location) dependent due to the different pole distances of the rotor 4 and the stators 2, 3 as well as the phase energization corresponding to commutation. With the rotated arrangement of the stators 2, 3 according to FIG. 7, a strongly energized stator pole is opposite a weakly energized stator pole when energized according to the current phase position and commutation. As a result, the current-induced magnetic flux distribution in the rotor 4 becomes asymmetrical. The magnetic flux density through the cross section of the rotor 4 is thereby more balanced in every angular range of the rotor 4. The resultant more uniform use of the ferromagnetic circuit reduces the magnetic resistance of the rotor 4 and thereby increases the overall magnetic flux.

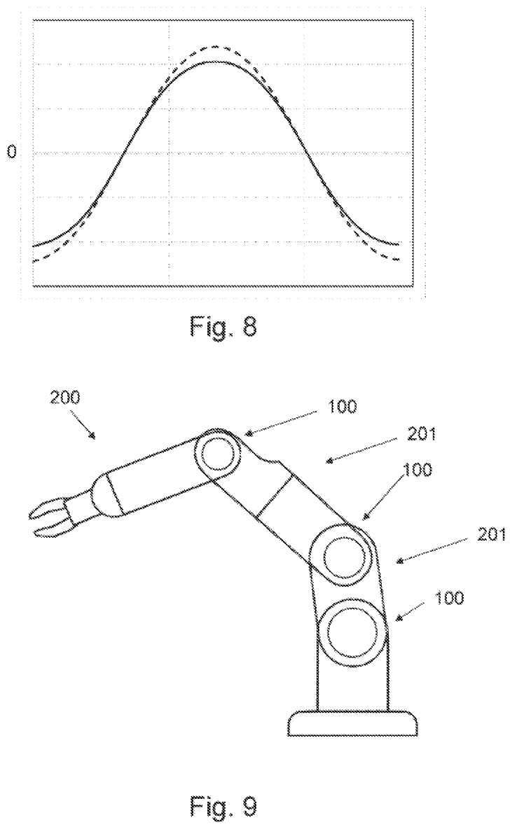

The representation in FIG. 8 shows the magnetic flux linkage over time or the electrical angle for the axial flux machine without offset according to FIGS. 4 and 6 (solid line) and for the axial flux machine 1 according to the disclosure with offset according to FIGS. 5 and 7 (dashed line). It can be seen that the maxima of the flux linkage for the axial flux machine with offset stator poles are greater in magnitude than for the conventional axial flux machine with symmetrical stator design without offset.

The representation in FIG. 9 shows an industrial robot 200 with a plurality of articulated arms 201, which are in each case rotatably connected via drive modules 100 according to the disclosure. The drive modules 100 comprise, in addition to an above-explained axial flux machine 1 as motor, a bearing arrangement, more particularly a rolling bearing arrangement, and possibly a gearbox.

### List of Reference Signs

1 Electric axial flux machine
2 First stator
3 Second stator
4 Rotor
5 Stator pole
6 Stator pole
7 Rotor pole pitch, rotor pole distance
8 Rotor pole
9 Permanent magnet
10 Circumferential direction
11 Distance between adjacent permanent magnets
12 Gap
13 Permanent magnet
14 Offset angles
15 Main body
20 Radial direction
30 Axial direction
100 Drive modules
200 Industrial robot
201 Articulated arm
B Flux density
U,V,W Phases

1. An electric axial flux machine comprising:
a first stator having a first multi-phase, more particularly three-phase, winding comprising N first stator poles, which are mutually spaced in a circumferential direction of the axial flux machine,
a second stator having a second multi-phase, more particularly three-phase, winding comprising N second stator poles, which are mutually spaced in a circumferential direction of the axial flux machine,
a plurality of first stator poles of the first winding and a plurality of second stator poles of the second winding being interconnected to form a first phase of the axial flux machine,
a rotor, which is disposed between the first stator and the second stator and which can be rotated relative to the first and second stators, and
a power source for energizing the first and second stators,
wherein the first stator and the second stator are configured and disposed such that the second stator poles of the first phase, which are provided as part of the second stator, are offset by an offset angle in the circumferential direction in relation to the first stator poles of the first phase, which are provided as part of the first stator, wherein the rotor has a plurality of rotor poles, wherein a rotor pole distance is determined by the angular distance between two adjacent rotor poles, and the offset angle is a single rotor pole distance or a multiple of the single rotor pole distance, and wherein the power source for energizing the first and second stators is designed such that the direction of the torque on the rotor caused by the first stator and second stator is the same.

2. The electric axial flux machine according to claim 1, wherein the power source is designed such that in the event that the offset angle corresponds to a single or an odd multiple of the rotor pole distance, the current direction in one of the stators is reversed compared to an axial flux machine without offset so that the direction of the torque on the rotor caused by the first stator and second stator is the same.

3. The electric axial flux machine according to claim 1, wherein the offset angle is twice the rotor pole distance or a multiple of twice the rotor pole distance.

4. The electric axial flux machine according to claim 1, wherein the offset angle is three times the rotor pole distance or a multiple of three times the rotor pole distance.

5. The electric axial flux machine according to claim 1, wherein the offset angle is determined as an integer n times the rotor pole distance, with
$$n = k g V ( \frac{N}{P h} , M ) \cdot \frac{P h}{2 N}$$
wherein
kgV least common multiple;
N number of stator poles;
Ph number of phases;
M number of rotor poles.

6. The electric axial flux machine according to claim 1, wherein the first winding is a toothed coil winding with first stator poles designed as coils and the second winding is a toothed coil winding with second stator poles designed as coils.

7. The electric axial flux machine according to claim 1, wherein the first stator comprises a first circuit board and the first winding has first conductor tracks which are arranged in the first circuit board and in that the second stator comprises a second circuit board and the second winding has second conductor tracks which are arranged in the second circuit board.

8. The electric axial flux machine according to claim 1, wherein the rotor has M rotor poles.

9. The electric axial flux machine according to claim 8, wherein the rotor poles are formed by permanent magnets embedded in a main body of the rotor, wherein the permanent magnets are magnetized in the circumferential direction of the axial flux machine.

10. The electric axial flux machine according to claim 8, wherein the rotor poles are formed by permanent magnets more particularly in the shape of sectors of a circle or ring arranged at one end face of the rotor.

11. A drive module for moving an articulated arm of an industrial robot having an electric axial flux machine according to claim 1.

12. An electric axial flux machine comprising:
a first stator having a first multi-phase winding comprising a plurality of first stator poles, wherein the plurality of first stator poles are spaced in a circumferential direction of the axial flux machine;
a second stator having a second multi-phase winding comprising a plurality of second stator poles, wherein the plurality of second stator poles are spaced in a circumferential direction of the axial flux machine;
wherein some of the first stator poles of the first winding and some of the second stator poles of the second winding are interconnected to form a first phase of the axial flux machine;
a rotor disposed between the first stator and the second stator, wherein the rotor is rotatable relative to the first stator and the second stator; and
a power source for energizing the first and second stators,
wherein the first stator and the second stator are configured such that the second stator poles of the first phase are offset by an offset angle in the circumferential direction relative to the first stator poles of the first phase, wherein the rotor comprises a plurality of rotor poles, wherein a rotor pole distance is determined by an angular distance between two adjacent rotor poles, and the offset angle comprises a single rotor pole distance or a multiple of the single rotor pole distance.

13. The electric axial flux machine according to claim 12, wherein the power source is configured such that in the event an offset angle corresponds to a single or an odd multiple of the rotor pole distance, the current direction in one of the stators is reversed compared to an axial flux machine without offset so that the direction of the torque on the rotor caused by the first stator and second stator is the same.

14. The electric axial flux machine according to claim 12, wherein the offset angle is twice the rotor pole distance or a multiple of twice the rotor pole distance.

15. The electric axial flux machine according to claim 12, wherein the offset angle is three times the rotor pole distance or a multiple of three times the rotor pole distance.

16. The electric axial flux machine according to claim 12, wherein the first winding is a toothed coil winding with first stator poles configured as coils and the second winding is a toothed coil winding with second stator poles configured as coils.

17. The electric axial flux machine according to claim 12, wherein the first stator comprises a first circuit board and the first winding includes first conductor tracks arranged in the first circuit board and the second stator comprises a second circuit board and the second winding includes second conductor tracks arranged in the second circuit board.

18. The electric axial flux machine according to claim 12, wherein the rotor includes a plurality of rotor poles.

19. An industrial robot comprising:
a plurality of articulating arms;
one or more drive modules, wherein the one or more drive modules are configured to move one or more of the articulated arms of the industrial robot, wherein at least some of the drive modules comprises an electrical axial flux machine, the electric axial flux machine comprising:
a first stator having a first multi-phase winding comprising a plurality of first stator poles, wherein the plurality of first stator poles are spaced in a circumferential direction of the axial flux machine;
a second stator having a second multi-phase winding comprising a plurality of second stator poles, wherein the plurality of second stator poles are spaced in a circumferential direction of the axial flux machine;
wherein some of the first stator poles of the first winding and some of the second stator poles of the second winding are interconnected to form a first phase of the axial flux machine;
a rotor disposed between the first stator and the second stator, wherein the rotor is rotatable relative to the first stator and the second stator; and
a power source for energizing the first and second stators,
wherein the first stator and the second stator are configured such that the second stator poles of the first phase are offset by an offset angle in the circumferential direction relative to the first stator poles of the first phase, wherein the rotor comprises a plurality of rotor poles, wherein a rotor pole distance is determined by an angular distance between two adjacent rotor poles, and the offset angle comprises a single rotor pole distance or a multiple of the single rotor pole distance.

20. The industrial robot according to claim 19, further comprising:
a motor; and
a rolling bearing arrangement.
